(19) United States
(12) Patent Application Publication
(10) Pub. No.: US 2026/0111078 A1
(43) Pub. Date: Apr. 23, 2026

(54) MOUSE

(71) Applicant: Shenzhen Newunite Electronic Co., Ltd, Shenzhen (CN)

(72) Inventor: Tony Tang, Shenzhen (CN)

(21) Appl. No.: 19/426,654

(22) Filed: Dec. 19, 2025

(30) Foreign Application Priority Data
Dec. 24, 2024 (CN) 2024231873022

(51) Int. Cl. G06F 3/0354

(52) U.S. Cl. CPC G06F 3/03543

(57) ABSTRACT

The present disclosure provides a mouse. By positioning an elastic element at the distal end of the transmission section and applying a sustained upward biasing force, the force-receiving section maintains a tendency to move toward the trigger switch during both static and pressing states, achieving "zero-threshold" triggering. This significantly reduces pressing pressure and operational fatigue. The trigger switch is set at an acute angle to the base wall, ensuring the trigger arm’s movement direction remains perpendicular to the trigger key’s mating surface. The key mechanism employs a lightweight yet high-strength material, complemented by weight-reducing holes and reinforcing ribs on the transmission section, achieving an overall lightweight design while maintaining the rigidity and deformation resistance of critical components. A multi-layered limiting system—comprising bearing housings, baffles, guide protrusions, positioning shafts, and limit plates—effectively suppresses unintended movement and wobbling of the key mechanism in all directions, ensuring precise, stable, and durable clicking actions.

### TECHNICAL FIELD

The present disclosure relates to the field of mouse technology, specifically to a mouse.

### BACKGROUND

As the core input device for computers, mouse button performance directly impacts user experience. Current mainstream mouse products still exhibit significant structural flaws. Firstly, excessive force is required to activate buttons, causing hand fatigue during prolonged gaming or office work. Secondly, noticeable latency in button response hinders precision operations. Furthermore, the wear-prone components degrade tactile feedback and shorten the lifespan. Thus, we propose a mouse to solve the above problems.

### SUMMARY

### Technical Issues Resolved

To overcome the shortcomings of the prior art, the present disclosure provides a mouse that solves the problems of existing mice, such as the need for large pressing force to trigger keys, perceptible delay in key trigger response, and easy wear and deformation of key components.

### Technical Solution

To achieve the above objectives, the present disclosure specifically adopts the following technical solution:

A mouse comprising a main body and a key mechanism, wherein the main body is equipped with a trigger switch and a control module, and the trigger switch is electrically connected to the control module.

The key mechanism is pivotally mounted on the mouse body via a lever, comprising a force-receiving section and a transmission section coupled thereto.

The transmission section is connected to an elastic element configured to apply a biasing force to the transmission section, causing the force-receiving section to have a tendency to move toward the trigger switch during both the stationary state and pressing process of the key mechanism.

Furthermore, the trigger switch is positioned at an acute angle to the bottom wall of the mouse body.

Furthermore, the acute angle ranges from 15° to 45°.

Furthermore, the force-receiving section is provided with a trigger arm extending toward the trigger switch, and the trigger switch has a trigger key with a mating surface.

The trigger arm is configured to maintain a motion direction perpendicular to the mating surface of the trigger key during pressing.

Furthermore, the end of the trigger arm is equipped with a contact block featuring a flat contact surface at its base. The area of this surface exceeds the cross-sectional area of the trigger arm's end, thereby increasing the contact area with the mating surface of the trigger key. The contact block is rectangular in shape.

Furthermore, the key mechanism comprises a key body, with the force-receiving section and transmission section respectively positioned at both ends of the key body.

The bottom of the transmission section, which is away from the force-receiving section, is equipped with a sleeve that internally fits over the top of the elastic element.

The transmission section is equipped with a rotating shaft extending to both sides near the sleeve, with bushings fitted at both ends of the rotating shaft.

The transmission section is provided with an assembly hole near the rotating shaft and a weight-reducing hole on one side of the assembly hole, and the assembly hole is elongated.

Furthermore, the mouse body consists of an upper shell, an inner lining, and a lower shell arranged sequentially from top to bottom. The key mechanism is positioned between the upper shell and the inner lining. A window is provided on the upper shell at the position corresponding to the force-receiving section, through which the force-receiving section protrudes to allow user pressing.

A positioning member is provided at the top of one end of the inner lining, and the positioning member is nested over the bottom of the elastic element.

The inner lining is provided with a stopper corresponding to the position of the rotating shaft's ends.

The inner lining also features a positioning shaft on the side of the stopper, with its top end extending through the assembly hole.

Furthermore, the stopper comprises:

A bearing housing featuring a shaft hole at its top that mates with the bushing to accommodate it. The shaft hole has a narrow opening at the top, narrower than the bushing's diameter, allowing the bushing to engage securely and restrict its movement perpendicular to the shaft axis, thereby limiting the key mechanism's lateral deflection.

A baffle, mounted on one side of the bearing housing, restricts the rotating shaft's axial displacement to limit the key mechanism's lateral movement.

The bearing housing has at least one arc-shaped guide protrusion on its side facing the transmission section. This guide protrusion is designed for clearance fit with the transmission section, effectively reducing the contact area and friction between the rotating transmission section and the bearing housing.

Furthermore, the key mechanism is fabricated from a lightweight yet high-strength material. The transmission section features upward-extending reinforcing ribs on both sides, with a limiting protrusion mounted at the top of one rib on its side.

A limit arm is also provided at the bottom of the force-receiving section, and a limit hole corresponding to the position of the limit arm is provided inside the inner lining, which engages with the limit arm.

Furthermore, the bottom of the upper shell features a limit plate extending toward the transmission section. The tip of the limit plate extends above the midsection of the rotating shaft, maintaining a clearance fit to vertically constrain the rotating shaft and prevent disengagement.

### Beneficial Effects

Compared with existing technologies, this disclosure provides a mouse with the following advantages:

This disclosure achieves "zero-threshold" triggering by positioning the elastic element at the distal end of the transmission section and applying a sustained upward biasing force, ensuring the force-receiving section maintains a tendency to move toward the trigger switch during both static and pressing states. This design significantly reduces pressing force and operational fatigue. The trigger switch is angularly positioned relative to the base wall, guaranteeing perpendicular alignment between the trigger arm's movement direction and the mating surface of the trigger key. This configuration optimizes the force transmission path, enhancing both response speed and tactile crispness. The key mechanism employs a lightweight yet high-strength material, complemented by weight-reducing holes and reinforcing ribs on the transmission section, achieving an overall lightweight design while preserving the rigidity and deformation resistance of critical components. A multi-layered limiting system—comprising bearing housings, baffles, guide protrusions, positioning shafts, and limit plates—effectively suppresses unintended movement and wobbling of the key mechanism in all directions, ensuring precise, stable, and durable clicking actions.

### BRIEF DESCRIPTION OF THE DRAWINGS

To describe the technical solutions in the embodiments of the present disclosure or the prior art more clearly, the following briefly introduces the accompanying drawings necessary for describing the embodiments or the prior art. Apparently, the accompanying drawings in the following description show only some embodiments of the present disclosure, and those of ordinary skill in the art may still derive other drawings from these drawings without any creative efforts.

FIG. 1 is a schematic diagram illustrating the primary structure of the mouse according to the present disclosure.

FIG. 2 is a schematic diagram showing the bottom structure of the mouse body.

FIG. 3 is a schematic diagram depicting the key mechanism structure.

FIG. 4 is an enlarged view of the structure indicated at region A in FIG. 3.

FIG. 5 is an exploded view of the key mechanism structure.

FIG. 6 is an enlarged view of the structure indicated at region A in FIG. 5.

FIG. 7 is an enlarged view of the structure indicated at region B in FIG. 5.

FIG. 8 is an exploded view of the primary structure of the mouse.

FIG. 9 is another exploded view of the primary structure of the mouse.

FIG. 10 is a schematic diagram of the mouse control board.

FIG. 11 is a schematic diagram of the limit plate structure.

FIG. 12 is a cross-sectional view of the limit plate and rotating shaft structure.

FIG. 13 is a cross-sectional view of the trigger switch and trigger arm structure.

Reference signs in the figures: 1. Mouse body; 11. Trigger switch; 111. Trigger key; 112. Mating surface; 12. Control module; 121. Mouse control board; 122. Side key panel; 1221. Side key button; 123. Scroll wheel; 124. DPI button; 125. Battery; 126. Charging port; 127. Optical sensor; 128. Main switch; 129. Function keys; 13. Upper housing; 131. Window; 14. Inner lining; 141. Positioning component; 142. Positioning shaft; 15. Lower housing; 16. Stopper; 161. Bearing housing; 1611. Shaft hole; 1612. Opening; 162. Baffle; 163. Guide protrusion; 17. Limit hole; 18. Limit plate; 19. Elastic element; 2. Key mechanism; 21. Key body; 211. Force-receiving section; 212. Transmission section; 2121. Sleeve; 2122. Assembly hole; 2123. Weight-reduction hole; 22. Trigger arm; 221. Contact block; 222. Contact surface; 23. Rotating shaft; 231. Bushing; 24. Reinforcement rib; 241. Limiting protrusion; 25. Limit arm.

### DETAILED DESCRIPTION

The embodiments of the present disclosure will be described in detail below. Examples of the embodiments are shown in the accompanying drawings. The same or similar reference signs throughout the drawings denote the same or similar elements or elements having the same or similar functions. The examples described below with reference to the drawings are illustrative and are intended to explain the present disclosure, but cannot be interpreted as limiting the present disclosure.

In the description of the present disclosure, it should be understood that the orientations or positional relationships indicated by the terms "upper", "lower", "front", "rear", "left", "right", "vertical", "horizontal", "top", "bottom", "inner", "outer", etc. are based on the orientations or positional relationships shown in the drawings, and are merely for the convenience of describing the present disclosure and simplifying the description. They do not indicate or imply that the device or element referred to must have a specific orientation or be constructed and operated in a specific orientation, and therefore cannot be understood as limitations of the present disclosure.

In addition, the terms "first" and "second" are merely used for descriptive purposes, and cannot be interpreted as indicating or implying relative importance or implicitly indicating the quantity of the indicated technical features. Thus, a feature defined by the term "first" or "second" may explicitly or implicitly include one or more such features. In the description of the present disclosure, "a plurality of" means two or more, unless otherwise specifically limited.

In the present disclosure, unless otherwise specified and limited, the terms "installation", "connection", "connected", "fixing", etc. should be understood in a broad sense. For example, "connection" may refer to a fixed connection, a detachable connection, integration, mechanical connection, electrical connection, direct connection, indirect connection via an intermediate medium, internal communication between two elements, or interaction between two elements. A person of ordinary skill in the art may understand the specific meanings of the above terms in the present disclosure according to specific situations.

An embodiment of the present disclosure discloses a mouse, comprising a main body 1 and a key mechanism 2, wherein the main body 1 is equipped with a trigger switch 11.

The key mechanism 2 is pivotally mounted on the mouse body 1 via a lever, comprising a force-receiving section 211 and a transmission section 212 coupled thereto.

The transmission section 212 is coupled to an elastic element 19, which is configured to apply a biasing force to the transmission section 212 during both the stationary state and pressing process of the key mechanism 2, causing the force-receiving section 211 to exhibit a tendency to move toward the trigger switch 11.

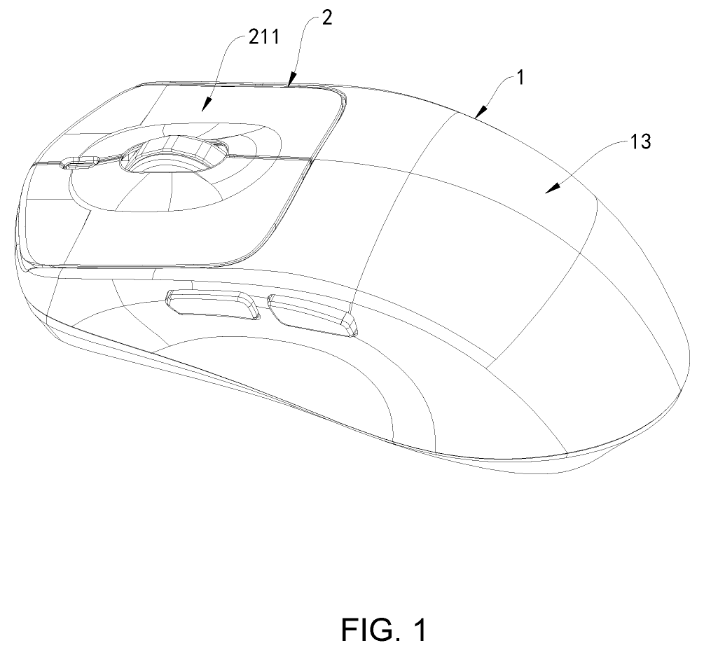

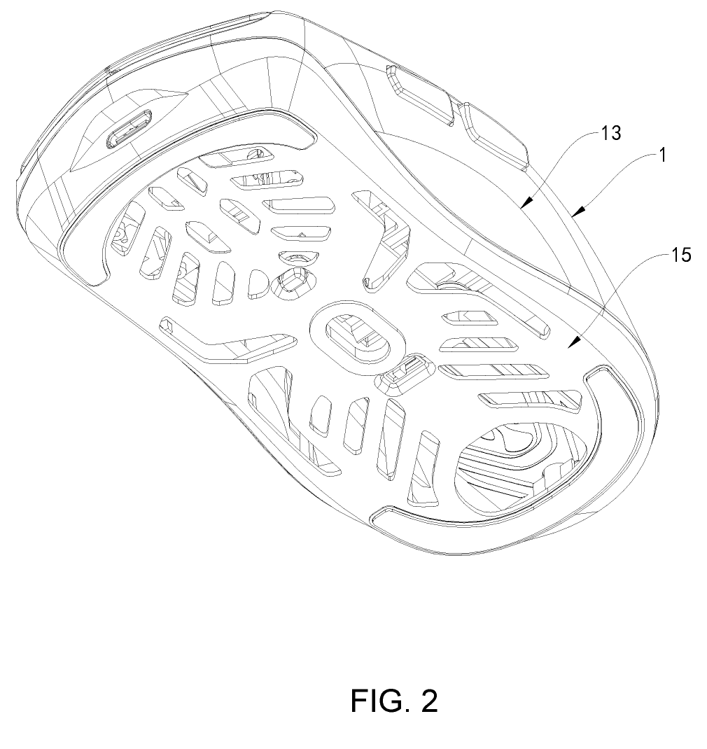

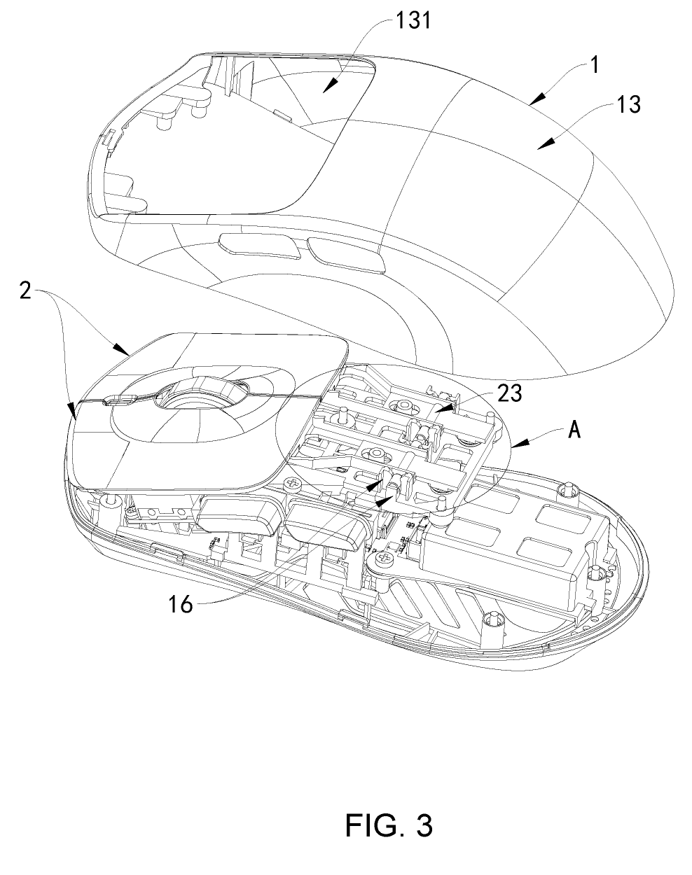

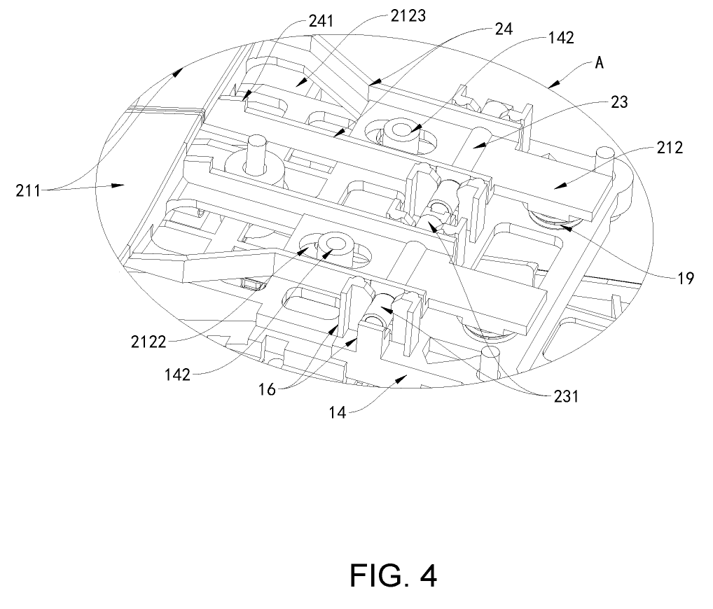

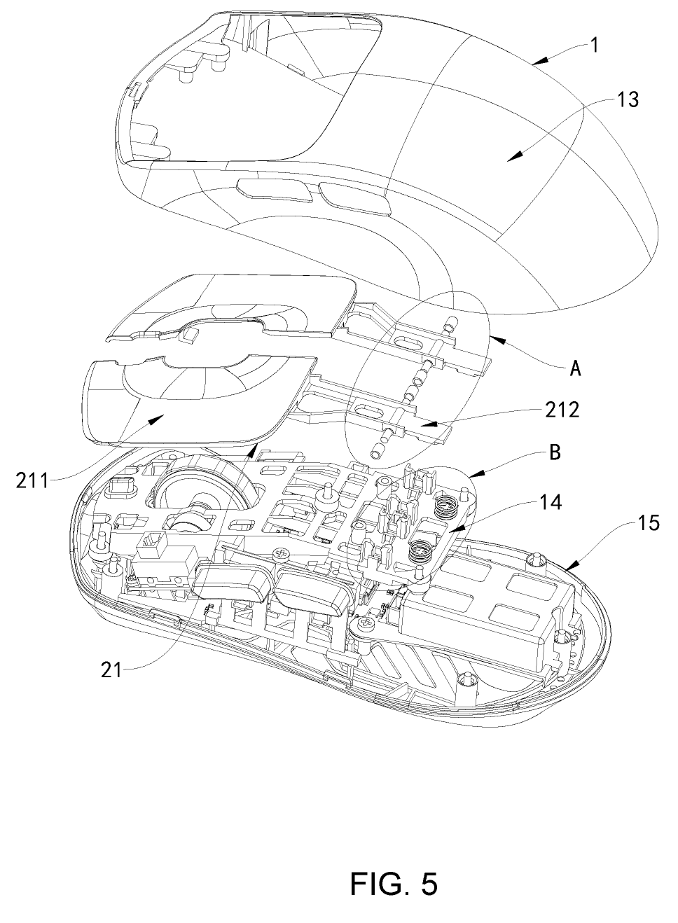

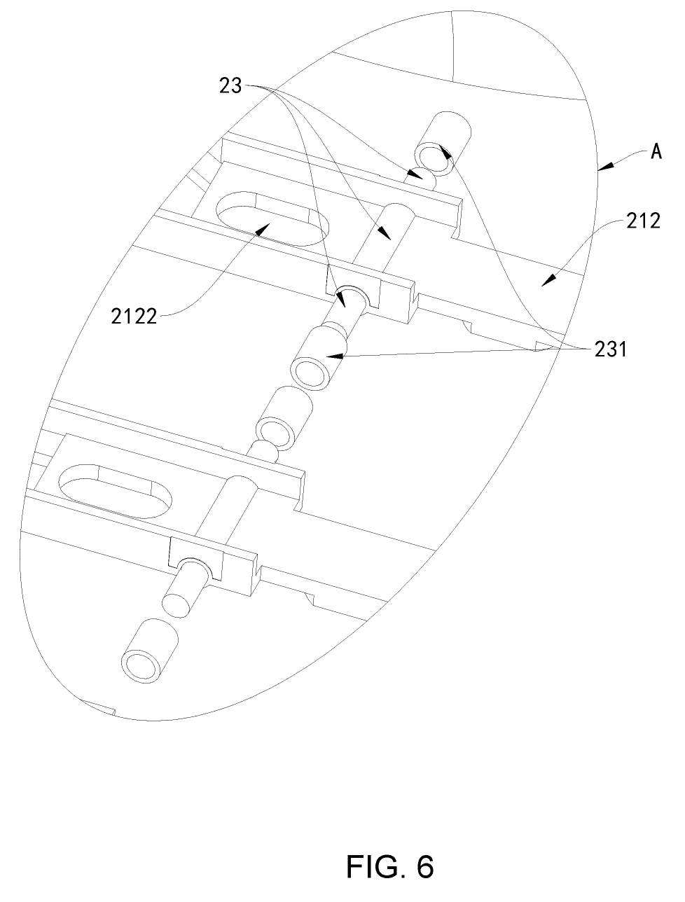

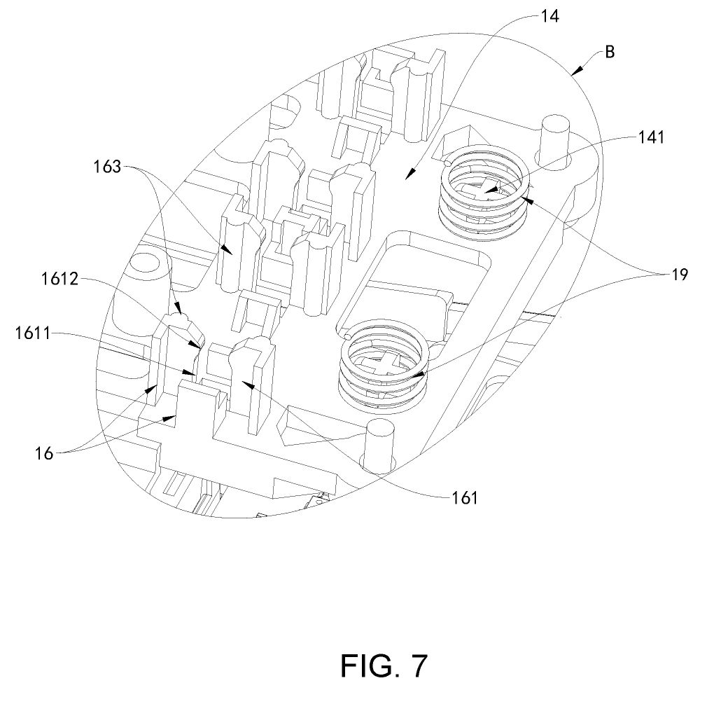

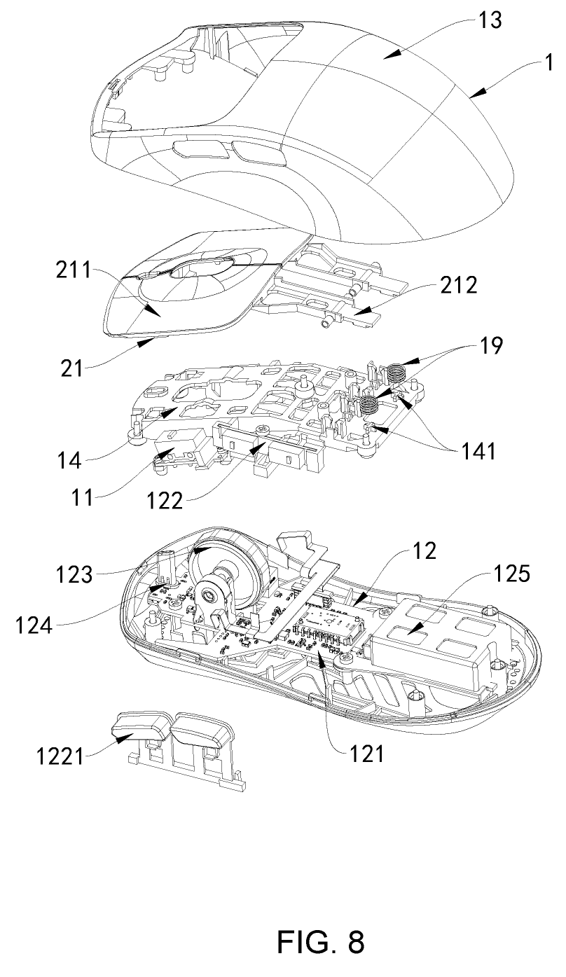

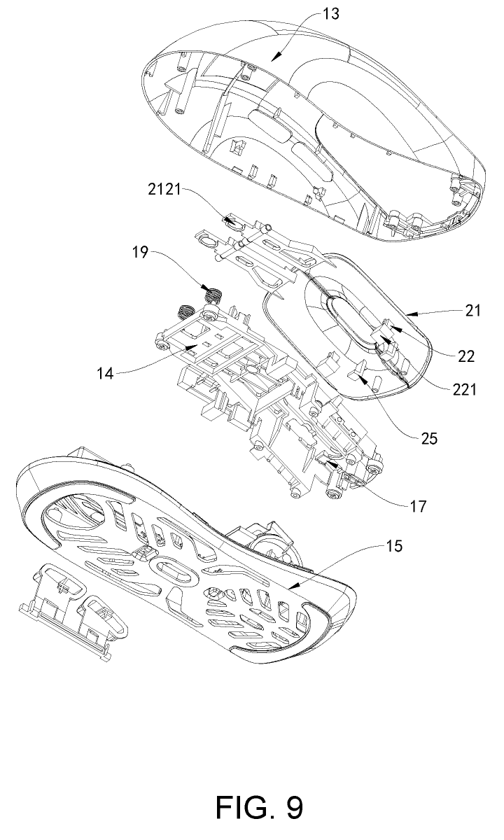

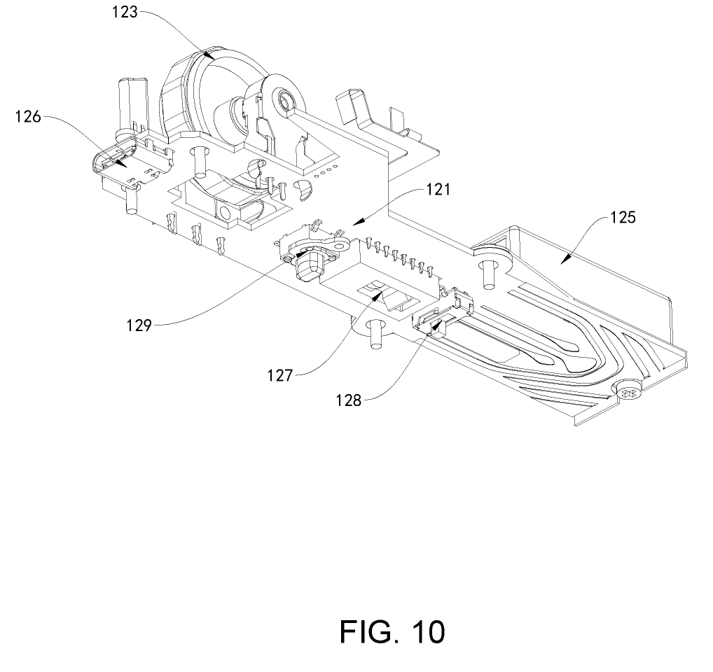

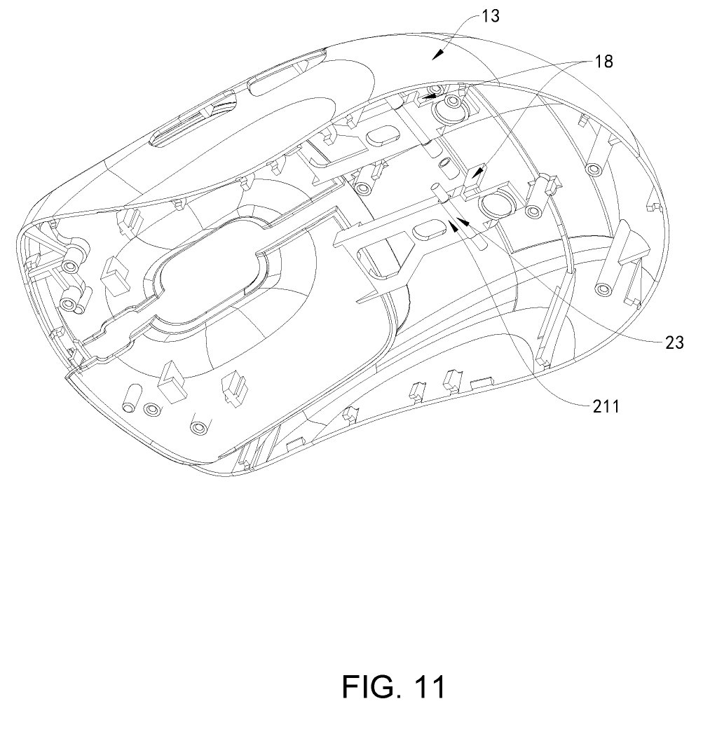

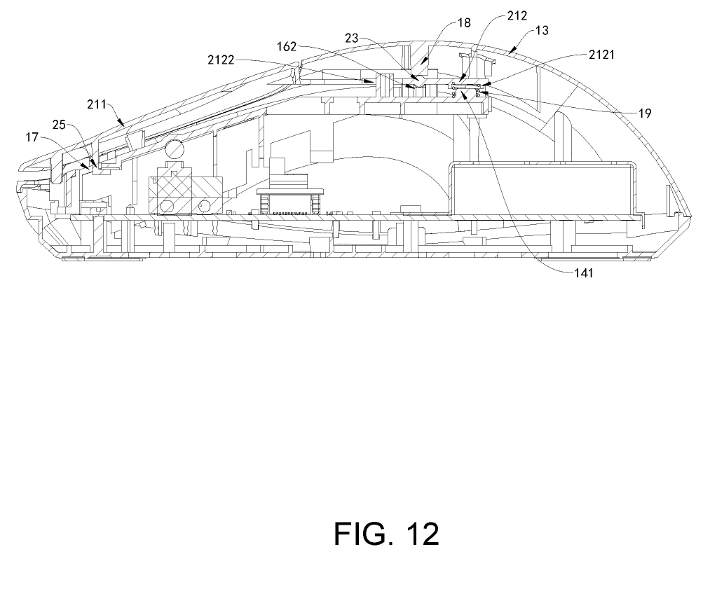

As shown in FIGS. 1-13, in some embodiments, the trigger switch 11 is positioned at an acute angle to the bottom wall of the mouse body 1.

In conventional mice, the trigger switch 11 is typically mounted horizontally, causing the key mechanism 2 to form an angle between the direction of the applied force and the switch's activation direction during arcuate motion, resulting in unnecessary force components. This design optimizes force transmission efficiency by tilting the trigger switch 11 at an acute angle, aligning the movement path of the trigger arm 22 more closely with the normal direction of the switch during pressing. This alignment directly converts user pressure into the switch's effective stroke, reducing pressure loss while enhancing trigger sensitivity and response speed. The mechanical principle fundamentally resolves the hysteresis issue inherent in traditional designs.

As shown in FIGS. 1-13, in some embodiments, the acute angle ranges from 15° to 45°.

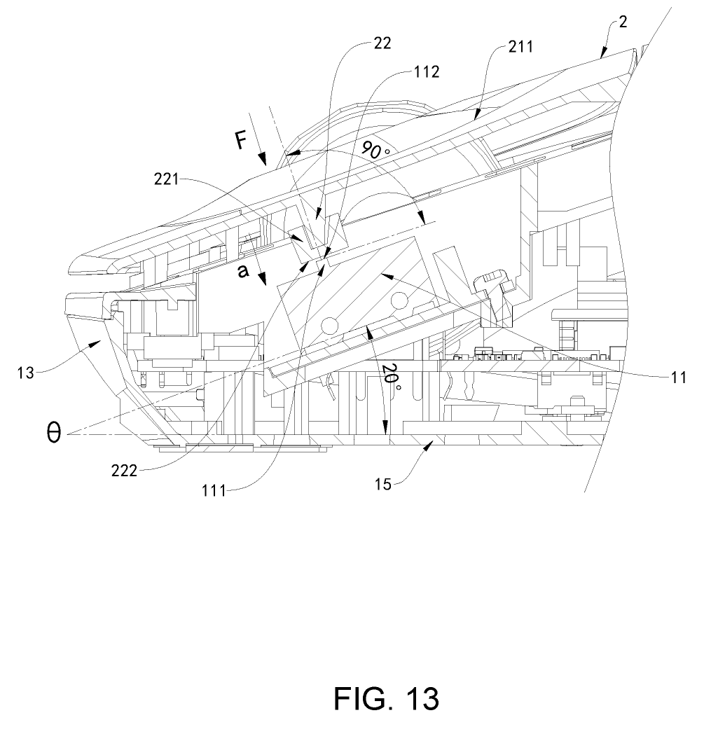

As shown in FIG. 13, the acute angle (θ) between the trigger switch 11 and the bottom wall of the mouse body is a critical design parameter. Extensive simulations and tests have demonstrated that setting this angle within the range of 15° to 45° optimizes force transmission efficiency and response speed. The principle is as follows:

Force transmission path optimization: When the trigger arm 22 moves along a direction substantially perpendicular to the mating surface 112 (i.e., the direction indicated by arrow a) during pressing, this angular range ensures that the majority of the pressing force (F) is used to overcome the compression spring force of the trigger key 111, rather than generating unnecessary lateral friction. This achieves a nearly vertical "up-and-down" trigger action, minimizing energy loss and thus requiring less pressing force from the user while providing crisper tactile feedback.

Structural compactness: If the angle is too small (e.g., less than 15°), the force transmission direction may be ideal, but it will excessively compress the vertical space above the trigger switch 11, causing interference between the key mechanism 2 and other internal components (e.g., mouse control board 121, inner lining 14), which hinders the slim design of the mouse body 1.

Balance between trigger efficiency and "zero-threshold": If the angle is excessively large (e.g., over 45°), the movement direction of the trigger arm 22 tends to become horizontal, reducing its vertical component. This not only increases the effective pressing force but also makes it difficult to maintain a stable "zero-threshold" state, thereby affecting the sensitivity and consistency of the trigger.

As shown in FIG. 13, in some embodiments, the acute angle (θ) is specifically set to 20°. This particular angle value is determined as the "optimal equilibrium point" through further optimization analysis within the preferred range of 15° to 45°, with its technical advantages manifested as follows:

The peak efficiency zone for force transmission occurs near 20°, where the movement of the trigger arm 22 forms the optimal angle with the mating surface 112 of the trigger switch 11. This configuration ensures the pressing force is entirely used to overcome the switch's reset spring, minimizing lateral forces and friction. The result is a nearly ideal "straight-up-and-down" trigger response, requiring minimal pressure for crisp and precise operation.

Optimal space utilization: It provides the most reasonable layout space for internal components, while ensuring the thin design and compact structure of the mouse body 1.

Extreme stability of the "zero-threshold" state: This configuration maintains an ultra-precise gap between the trigger arm 22 and the mating surface 112 of the trigger switch 11 in static conditions. The gap is precisely calibrated to prevent pre-triggering caused by component tolerances or environmental variations, while instantly closing under minimal user pressure. This delivers the most sensitive and reliable "zero-threshold" trigger performance. The 20° design ensures this delicate balance remains easily achievable and controllable in mass production.

As shown in FIGS. 1-13, in some embodiments, the force-receiving section 211 is provided with a trigger arm 22 extending toward the trigger switch 11. The trigger switch 11 includes a trigger key 111, which has a mating surface 112.

The trigger arm 22 is configured to maintain a substantially perpendicular motion direction relative to the mating surface 112 of the trigger key 111 during pressing.

When the force-receiving section 211 of the key body 21 is pressed, the trigger arm 22 moves along a direction nearly perpendicular to the mating surface 112 of the trigger key 111. This design achieves near-perfect front contact and force transmission, effectively eliminating lateral slippage and friction. The result is an exceptionally crisp and responsive trigger feel, akin to a "straight-up-and-down" mechanical action. Moreover, it prevents component wear caused by oblique force application, thereby extending the service life and ensuring physical consistency in every trigger cycle.

As shown in FIGS. 1-13, in some embodiments, the trigger arm 22 is provided with a contact block 221 at its end. The contact block 221 has a flat contact surface 222 at its base, and the area of this surface is larger than the cross-sectional area of the trigger arm 22's end. This design increases the contact area between the trigger arm and the mating surface 112 of the trigger key 111. The contact block 221 is rectangular in shape.

The independent contact block 221 functions as a force-transmitting "terminal actuator", fundamentally transforming the inherently unstable "point contact" or "line contact" into stable "surface contact". This design significantly increases the contact area, thereby dispersing the pressure exerted on the trigger switch 11 and its mating surface 112. The design offers the following advantages:

First, it fundamentally prevents stress concentration, thereby avoiding surface indentations and wear caused by prolonged mechanical stress on the trigger switch 11, significantly enhancing the product's durability.

Secondly, the enlarged contact surface 222 functions as a stable base, ensuring reliable and consistent triggering even with slight pressure deviations, effectively eliminating issues like false triggers or loose engagement caused by poor contact.

As shown in FIGS. 1-13, in some embodiments, the key mechanism 2 comprises a key body 21, with the force-receiving section 211 and transmission section 212 respectively positioned at both ends of the key body 21.

The bottom of the transmission section 212, opposite to the force-receiving section 211, is fitted with a sleeve 2121 that internally engages with the top of the elastic element 19.

The transmission section 212 is equipped with a rotating shaft 23 near the sleeve 2121, extending to both sides of the transmission section. Both ends of the rotating shaft are fitted with bushings 231.

The transmission section 212 features an assembly hole 2122 near the rotating shaft 23, with a weight-reducing hole 2123 positioned adjacent to it. The assembly hole 2122 is elongated in shape.

The sleeve 2121 provides precise positioning and guidance for the elastic element 19, ensuring its force is consistently transmitted along the axis. The combination of the rotating shaft 23 and the bushings 231 forms a low-friction, high-stability rotating pair, serving as a reliable fulcrum for lever motion. This achieves precise and smooth rotation of the lever mechanism, ensuring accurate application of elastic force.

The assembly hole 2122 engages with the positioning shaft 142, where the contact between the hole wall and the shaft effectively restricts lateral movement of the transmission section 212, thereby enhancing the transverse stability of the key mechanism 2. This design also eliminates redundant material, contributing to weight reduction and ensuring optimal "zero-threshold" performance.

The weight-reducing hole 2123 on the transmission section 212 serves to selectively remove materials that contribute minimally to structural stiffness. This directly reduces the mass moment of the key mechanism 2, particularly at the lever's distal end (transmission section 212). By significantly decreasing the mechanism's moment of inertia, it enables faster activation and reset, thereby improving click response speed while also helping to reduce material costs.

As shown in FIGS. 1-13, in some embodiments, the mouse body 1 comprises two parallel key mechanisms 2 serving as the left and right buttons. These identical yet independent mechanisms are arranged side by side within the mouse body, each including a key body 21, a force-receiving section 211, a transmission section 212, a rotating shaft 23, and an elastic element 19. The transmission section 212 of each mechanism connects to an independent elastic element 19. Correspondingly, two trigger switches 11 are installed inside the mouse body, each positioned opposite the trigger arm 22 of a key mechanism 2. Both trigger switches 11 are electrically connected to the control module 12.

As shown in FIGS. 1-13, in some embodiments, the mouse body 1 comprises an upper shell 13, an inner lining 14, and a lower shell 15 arranged sequentially from top to bottom. The key mechanism 2 is positioned between the upper shell 13 and the inner lining 14. A window 131 is provided on the upper shell 13 at the location corresponding to the force-receiving section 211, through which the force-receiving section 211 extends to allow user pressing.

A positioning member 141 is mounted at the top of one end of the inner lining 14, with one end of the positioning member 141 fitting over the bottom of the elastic element 19.

The inner lining 14 is provided with a stopper 16 corresponding to the position of the rotating shaft 23's ends.

The inner lining 14 is also equipped with a positioning shaft 142 on one side of the stopper 16, with its top end extending through the assembly hole 2122.

The window 131 on the upper shell 13 exposes the force-receiving section 211, serving as the user interaction interface. The positioning member 141 at the top of the inner lining 14 is inserted into the elastic element 19, providing a sturdy base to prevent displacement during operation and ensuring stable biasing force. The positioning shaft 142 on the inner lining 14 extends through the assembly hole 2122 of the transmission section 212, forming a floating constraint that achieves precise functional zoning (upper shell 13: appearance and interaction; inner lining 14: core mechanism support and positioning; lower shell 15: basic encapsulation). This design significantly enhances the internal structure's orderliness, stability, and assembly convenience.

As shown in FIGS. 1-13, in some embodiments, the stopper 16 comprises:

The bearing housing 161 has a shaft hole 1611 at its top, designed to accommodate the bushing 231. The shaft hole 1611 features a narrow opening 1612 at its top, narrower than the bushing's diameter. This design allows the bushing to be securely engaged within the shaft hole, restricting its movement perpendicular to the rotation axis of the rotating shaft 23 and thereby limiting the forward and backward deflection of the key mechanism 2.

The baffle 162, mounted on one side of the bearing housing 161, restricts the rotating shaft 23's axial displacement to limit the key mechanism 2's lateral movement.

The bearing housing 161 has at least one arc-shaped guide protrusion 163 on its side facing the transmission section 212. This guide protrusion 163 is designed for clearance fit with the transmission section 212, effectively reducing the contact area and friction between the rotating transmission section 212 and the bearing housing 161.

The bearing housing 161's internal shaft hole 1611, with its tapered top design, allows the bushing 231 to be clamped from above and prevents it from disengaging. Its side walls also restrict the bushing's movement perpendicular to the rotation axis of the rotating shaft 23, effectively suppressing the key mechanism 2's lateral displacement.

The L-shaped baffle 162, with its vertical and horizontal arms forming a corner, provides dual constraint on the bushing 231 and rotating shaft 23 from both the end and bottom surfaces. This eliminates any potential axial clearance, ensuring precise and stable positioning. When the mouse vibrates or drops, the rotating shaft 23 experiences upward impact forces. The horizontal section of the L-shaped baffle 162 directly supports the bushing 231, working in tandem with the limit plate 18 on the upper shell 13 to create a clamping anti-disengagement structure. This significantly enhances the retaining force of the rotating shaft 23 under extreme conditions and improves the robustness of the entire key mechanism 2.

During assembly, the L-shaped baffle 162 provides a precise mounting surface for the bushing 231, facilitating automated production. Moreover, this comprehensive wrapping constraint ensures that the pivot point of the rotating shaft 23 remains secure against wear throughout its service life, thereby maintaining consistent and stable tactile feedback for the key mechanism 2 over time.

The guide protrusion 163 converts the potential large-area sliding friction between the transmission section 212 and the bearing housing 161 into small-area arc-shaped contact that aligns with the motion path. This significantly reduces rotational friction and wear, resulting in a smoother tactile feel for the key body 21. Additionally, it enhances guidance and improves overall motion quality.

As shown in FIGS. 1-13, in some embodiments, the key mechanism 2 is fabricated from a lightweight, high-strength material. The transmission section 212 features upward-extending reinforcing ribs 24 on both sides, with a limiting protrusion 241 positioned at the top of one rib on its side.

The bottom of the force-receiving section 211 is equipped with a limit arm 25, while the inner lining 14 features a corresponding limit hole 17 that aligns with the position of the limit arm 25 and engages with it.

The key mechanism 2 may be fabricated from one of the following materials: magnesium alloy, aluminum alloy, magnesium-aluminum alloy, nickel alloy, zinc alloy, ABS plastic, or carbon fiber composite. These materials all meet the core requirements of reducing motion inertia, ensuring structural rigidity, and achieving long-term fatigue resistance. Notably, magnesium-aluminum alloy has been proven to be the optimal solution for this disclosure. Its selection as the preferred material is not coincidental but stems from its outstanding comprehensive performance in the specific application scenario of mouse keys:

Optimal Lightweight Design with Superior Specific Strength: Magnesium-aluminum alloys exhibit significantly lower density than conventional materials such as standard ABS plastic, effectively reducing the moving mass of the key mechanism 2. This design feature directly translates to minimized inertial resistance, enabling the key body 21 to respond with greater agility during pressing and reset operations—thus achieving enhanced responsiveness and crisp tactile feedback. Furthermore, the alloy’s exceptional specific strength (strength-to-density ratio) ensures mechanical durability to withstand repeated click impacts while maintaining an ultra-thin profile.

Excellence in Rigidity and Dimensional Stability: Compared to conventional engineering plastics, magnesium-aluminum alloys exhibit a significantly higher elastic modulus, meaning their self-deformation is negligible under the same pressing force. This high rigidity ensures that the pressing force is transmitted almost losslessly and directly to the trigger switch 11, eliminating energy loss and tactile ambiguity caused by component deformation—perfectly supporting the precise force transmission path required for "zero-threshold" triggering. Additionally, their superior thermal stability and creep resistance ensure that the key mechanism 2 maintains high dimensional stability and critical clearances (such as the "zero-threshold" clearance) even under long-term use and environmental temperature variations.

Long-lasting Durability and Reliability: The exceptional fatigue strength and wear resistance of magnesium-aluminum alloys enable the key mechanism 2 to withstand over ten million click cycles in testing. This fundamentally prevents the plastic deformation or "double-click" failures that plague plastic materials under prolonged stress, ensuring consistent click responsiveness throughout the product’s entire lifecycle.

Reinforcing ribs 24 are a critical design element that ensures structural rigidity after lightweighting. By optimizing the cross-sectional shape, they significantly increase the component’s moment of inertia—analogous to how a flat sheet of paper bends easily but resists bending when folded at a right angle. This greatly enhances the bending stiffness of the transmission section 212, ensuring that the user’s pressing force is fully utilized to actuate the trigger switch 11 rather than dissipating through deformation of the transmission section itself—thus guaranteeing efficient force transmission and a "solid" tactile feedback.

The limiting protrusion 241 features a sloped top surface that provides guidance and cushioning during final assembly or under abnormal forces. Its apex contacts the inner side of the mouse upper shell 13, working in tandem to restrict excessive upward movement of the transmission section 212 during rebound. This prevents floating or impact noises while effectively dispersing concentrated stress during contact with the upper shell, mitigating plastic deformation and wear from prolonged use.

The L-shaped limit arm 25 extends through the limit hole 17 at its base, engaging with one side wall of the hole to form a hook-like engagement mechanism. This design establishes a three-dimensional spatial constraint, providing a precise mechanical stop for the rebound motion of the key mechanism 2 after pressure release. It ensures the force-receiving section 211 always returns to its preset initial height—a fundamental requirement for maintaining a stable "zero-threshold" clearance. The engagement mechanism also effectively suppresses minor vibrations or wobbling at the end of rebound, enhancing tactile responsiveness. An additional pivot point at the rear of the force-receiving section 211 works in tandem with the pivot point of the rotating shaft 23 to resist unintended forces, preventing the key mechanism 2 from loosening or shifting within the mouse body 1 and significantly improving the structural integrity and reliability of the system.

As shown in FIGS. 1-13, in some embodiments, the bottom of the upper shell 13 extends toward the transmission section 212 to form a limit plate 18. The end of the limit plate 18 extends above the central region of the rotating shaft 23 on the transmission section 212, maintaining a clearance fit with this region to vertically constrain the rotating shaft 23 and prevent disengagement.

Functioning as a safety barrier, the limit plate 18 specifically prevents the rotating shaft 23 from detaching from the lower bearing housing 161 during abnormal upward impacts (e.g., transportation vibrations or accidental drops). Together with the bearing housing 161, it forms a clamping structure that prevents vertical disengagement of the rotating shaft 23. This design significantly enhances the structural robustness and reliability of the entire key mechanism 2 under extreme conditions, ensuring the stability of the pivot point throughout the product’s lifecycle and safeguarding core functionality. By achieving critical protection through a simple structure, it elevates the product’s overall quality and durability.

As shown in FIGS. 1-13, in some embodiments, the control module 12 comprises a mouse control panel 121 fixed to the top of the lower shell 15, and a side key panel 122 electrically connected to the mouse control panel 121 and positioned on one side of the inner lining 14. The side key panel 122 features a side key button 1221 extending to one side of the upper shell 13. The mouse control panel 121 integrates a scroll wheel 123 at one end of its top, with a DPI button 124 located adjacent to the scroll wheel 123, and a battery 125 at the other end. Both the DPI button 124 and the scroll wheel 123 protrude above the window 131 and are positioned between the two key mechanisms 2. The mouse control panel 121 also integrates a charging port 126 at one end of its bottom, and an optical sensor 127 in the central bottom area, with a main switch 128 and a function key 129 on either side of the optical sensor 127. The lower shell 15 is designed with a perforated structure.

The integrated design of the control module 12 and the perforated lower shell 15 achieves optimal internal space utilization and balanced weight through highly integrated core components with rational zoning. The layout of the scroll wheel 123 and DPI button 124 protruding between the key mechanisms 2 ensures smooth and convenient switching between high-frequency operations, significantly enhancing human-computer interaction efficiency. The comprehensive design of the charging port 126 and battery 125 seamlessly supports both wired and wireless modes, ultimately delivering a compact, precise, and versatile modern mouse product.

In some embodiments, the elastic element 19 is a compression spring housed between the sleeve 2121 at the end of the transmission section 212 and the mouse body 1, which generates a restoring force through pre-compression to provide a stable, linear biasing force.

The elastic element 19 may also be a torsion spring mounted on the rotating shaft 23. Its two ends act on the transmission section 212 and the mouse body 1, respectively, generating the required biasing force through torsional deformation.

Furthermore, other types of elastomers—including leaf springs, rubber pads, or silicone components—shall be deemed within the scope of the present disclosure, provided they are configured to apply an upward biasing force to the transmission section 212. The selection of different elastic elements 19 may be optimized for cost, tactile feedback response, and service life.

In certain embodiments, the elastic element 19 is configured to provide a biasing force that induces downward movement of the force-receiving section 211. Thus, its placement is not restricted to the distal end of the transmission section 212. It should be noted that the elastic element 19 may also be positioned at the midsection or other suitable locations of the transmission section 212, provided it can exert the biasing force on the force-receiving section 211 through the lever principle. Such configurations are all considered within the scope of the present disclosure.

In certain embodiments, the type of trigger switch 11 is not the focus of this disclosure, which centers on the synergistic mechanical structure between the key mechanism 2 and the trigger switch 11 rather than its specific sensing principle. Thus, the trigger switch 11 is not limited to a mechanical microswitch. It may be replaced by non-contact electronic switches such as optical switches (triggered by the blocking of the trigger arm 22 or through optical pathways) or Hall effect switches (triggered by changes in the relative position of a magnet on the trigger arm 22 and the switch). Such replacements can also achieve "zero-threshold" triggering and rapid response, potentially extending the service life.

In certain embodiments, the application scope of the disclosure is expanded: The key mechanism 2, which achieves low operating force and rapid triggering through pre-applied biasing force, is not limited to traditional mice. This innovative mechanism can be widely applied to other input devices requiring precise and rapid clicking operations, such as click buttons on trackballs, shortcut keys on graphics tablets, or physical buttons on touchpads. Any input device incorporating the features of the key mechanism 2 described herein is protected by the present disclosure.

In summary, by positioning the elastic element 19 at the distal end of the transmission section 212 and applying a sustained upward biasing force, the force-receiving section 211 maintains a tendency to move toward the trigger switch 11 during both stationary and pressing states, achieving "zero-threshold" triggering. This significantly reduces pressing force and operational fatigue. The trigger switch 11 is set at an acute angle to the base wall, ensuring the trigger arm 22’s movement direction remains perpendicular to the mating surface 112 of the trigger key 111. This design optimizes the force transmission path, enhancing trigger response speed and crisp tactile feedback. The key mechanism 2 employs a lightweight, high-strength material, combined with weight-reducing holes 2123 and reinforcing ribs 24 on the transmission section 212, achieving an overall lightweight design while maintaining the rigidity and deformation resistance of critical components. A multi-layered limiting system—comprising bearing housings 161, baffles 162, guide protrusions 163, positioning shafts 142, and limit plates 18—effectively suppresses unintended movement and wobbling of the key mechanism 2 in all directions, ensuring precise, stable, and durable clicking actions.

Finally, it should be noted that the above description constitutes only preferred embodiments of the present disclosure and is not intended to limit its scope. Although the disclosure has been described in detail with reference to the aforementioned embodiments, those skilled in the art may still modify the technical solutions described therein or make equivalent substitutions of certain technical features. Any modifications, equivalent substitutions, or improvements made within the spirit and principles of the present disclosure shall be included within the scope of protection of the present disclosure.

The embodiments in this specification are all described in a progressive manner, with each embodiment focusing on differences from other embodiments. The same or similar parts of the embodiments may be referenced to each other. The device disclosed in the embodiments corresponds to the method disclosed in the embodiments and is thus described relatively simply; reference may be made to the description of the method for related parts.

The above descriptions of the disclosed embodiments enable those skilled in the art to implement or use the present disclosure. Various modifications to these embodiments are obvious to those skilled in the art, and the general principles defined herein may be implemented in other embodiments without departing from the spirit or scope of the present disclosure. Therefore, the present disclosure will not be limited to the embodiments described herein but will extend to the widest scope consistent with the principles and novelty disclosed herein.

1. A mouse comprising a main body and a key mechanism, wherein the main body houses a trigger switch and a control module, the trigger switch being electrically connected to the control module;
the key mechanism is pivotally mounted on the mouse body via a lever, comprising a force-receiving section and a transmission section coupled thereto;
the transmission section is coupled to an elastic element, which is configured to apply a biasing force to the transmission section during both the stationary state and pressing process of the key mechanism, causing the force-receiving section to exhibit a tendency to move toward the trigger switch.

2. The mouse according to claim 1, wherein the trigger switch is positioned at an acute angle to the base wall of the mouse body.

3. The mouse according to claim 2, wherein the acute angle ranges from 15° to 45°.

4. The mouse according to claim 1, wherein the force-receiving section is provided with a trigger arm extending toward the trigger switch;
the trigger switch is provided with a trigger key having a mating surface; the trigger arm is configured to maintain a motion direction perpendicular to the mating surface of the trigger key during pressing.

5. The mouse according to claim 4, wherein the trigger arm is provided with a contact block at its end, the contact block having a flat contact surface at its base; the area of the contact surface is larger than the cross-sectional area of the trigger arm’s end to increase the contact area with the mating surface of the trigger key; and the contact block is a rectangular block.

6. The mouse according to claim 1, wherein the key mechanism comprises a key body, with the force-receiving section and the transmission section respectively disposed at both ends of the key body;
the bottom of the transmission section, opposite to the force-receiving section, is fitted with a sleeve that internally engages with the top of the elastic element;
the transmission section is equipped with a rotating shaft extending to both sides near the sleeve, with bushings fitted at both ends of the rotating shaft;
the transmission section is provided with an assembly hole near the rotating shaft, and a weight-reducing hole located on one side of the assembly hole; the assembly hole is elongated.

7. The mouse according to claim 6, wherein: the mouse body comprises an upper shell, an inner lining, and a lower shell arranged sequentially from top to bottom; the key mechanism is disposed between the upper shell and the inner lining; a window is provided on the upper shell at the position corresponding to the force-receiving section, through which the force-receiving section extends to expose itself for user pressing;
a positioning member is mounted at the top of one end of the inner lining, with one end of the positioning member fitting over the bottom of the elastic element;
the inner lining is equipped with a stopper aligned with the end position of the rotating shaft;
the inner lining is further provided with a positioning shaft on one side of the stopper, with its top end extending through the assembly hole.

8. The mouse according to claim 7, wherein the stopper comprises:
a bearing housing having a top-mounted shaft hole that mates with the bushing to
accommodate it; the shaft hole features a narrow opening at its top, narrower than the bushing’s diameter, allowing the bushing to engage securely within the shaft hole while restricting its movement perpendicular to the rotation axis, thereby limiting the key mechanism from tilting forward or backward;
a baffle mounted on one side of the bearing housing, which restricts the rotating shaft from axial displacement, thereby limiting the lateral deflection of the key mechanism;
the bearing housing features at least one arc-shaped guide protrusion on its side facing the transmission section; the guide protrusion is designed for clearance fit with the transmission section, effectively reducing the contact area and friction between the rotating transmission section and the bearing housing.

9. The mouse according to claim 7, wherein: the key mechanism is fabricated from a lightweight, high-strength material; the transmission section has reinforcing ribs extending upward on both sides, with a limiting protrusion formed at the top of the rib on one side of the transmission section;
the bottom of the force-receiving section is equipped with a limit arm, while the inner
lining features a corresponding limit hole that aligns with the position of the limit arm and engages with it.

10. The mouse according to claim 7, wherein the upper shell is provided with a limit plate extending from its bottom toward the transmission section; the limit plate extends above the central region of the rotating shaft on the transmission section and maintains a clearance fit with said region to vertically limit the rotating shaft and prevent its disengagement.
